(19) United States
(12) Patent Application Publication
(10) Pub. No.: US 2008/0136114 A1
(43) Pub. Date: Jun. 12, 2008

(54) Vacuum seal for high speed generator

(76) Inventors: Murtuza Lokhandwalla, Clifton Park, NY (US); Kirubaharan Sivasubramaniam, Troy, NY (US); Evangelos Trifon Laskaris, Schenectady, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/635,748

(22) Filed: Dec. 7, 2006

(51) Int. Cl. F16J 15/36

(52) U.S. Cl. 277/392

(57) ABSTRACT

The present invention solves the aforementioned problems by providing a vacuum seal assembly for a high power generator stub shaft which includes a seal stator encircling the stub shaft and a plurality of oil seals disposed on an inner diameter of the seal stator and encircling the stub shaft. Adjacent oil seals form a plurality of seal cavities between the stub shaft and the seal stator, and define gaps between each oil seal and the stub shaft for receiving a lubricant film. At least one seal feed conduit extending through the seal stator into the plurality of seal cavities to provide lubricant to the seal assembly.

### FEDERAL RESEARCH STATEMENT

This invention was made with Government support under contract FA8650-04-G-2466-0001 awarded by U.S. Air Force Research Laboratory. The Government has certain rights in the invention.

### BACKGROUND

This invention relates generally to electrical machines, and more particularly to a vacuum seal for sealing a rotating shaft of a high speed generator.

Power density in generators can be improved by increasing the mechanical speed of the rotor. Increased rotor speed, however, results in increased friction and windage losses. The losses can be reduced by evacuating the chamber in which the rotor is located and operating the rotor in a vacuum environment. Because the rotor shaft extends from outside the vacuum chamber into the vacuum chamber, a vacuum seal around the rotor shaft is necessary to maintain the integrity of the vacuum chamber. Traditional seal types, such as brush seals, carbon seals, or other clearance seals can be employed, but the leakage rates from these types of seals are too high for high power applications. Another option is to utilize a ferrofluidic seal. A ferrofluidic seal establishes a seal by applying a magnetic field to a magnetic fluid (a ferrofluid). The ferrofluid assumes the shape of a liquid o-ring and seals the desired area. Ferrofluidic seals can reduce the seal leakage rates to acceptable levels, but are not effective when the shaft is rotating at high surface speeds (DN of about 1,200,000). Generic “O-ring” seals or “piston-ping” seals have been used in some applications, for example, high speed racing engines, but these typically have a more relaxed vacuum requirement (>1 Torr).

What is needed is a vacuum seal with leakage rates comparable to a ferrofluidic seal, but which is effective at the high DN values that can be achieved by operating the rotor in a vacuum chamber.

### BRIEF DESCRIPTION

Embodiments of the present invention solve the aforementioned challenges through a vacuum seal assembly for a high power generator stub shaft which comprises a seal stator disposed about the stub shaft, and a plurality of oil seals disposed on an inner diameter of the seal stator and encircling the stub shaft. The oils seals define gaps between the oil seals and the stub shaft for receiving a lubricant film, and adjacent oil seals form a plurality of seal cavities between the stub shaft and the seal stator. At least one seal feed conduit extending through the seal stator into the plurality of seal cavities to provide lubricant to the seal assembly. A lubricant film is located at an inner diameter of each oil seal bridging a gap between the stub shaft and the oil seals. The lubricant film forms the vacuum seal around a circumference of the stub shaft.

These and other advantages and features will be more readily understood from the following detailed description of preferred embodiments of the invention that is provided in connection with the accompanying drawings.

### BRIEF DESCRIPTION OF THE DRAWINGS

FIG. 1 is a partial cross-sectional view of a high speed generator rotor and shaft assembly including the bearing assembly and an embodiment of an improved vacuum seal assembly.

FIG. 2 is an enlarged view of the circled portion of FIG. 1, illustrating a carbon seal ring and a stub shaft.

FIG. 3 is a partial cross-sectional view of a high speed generator rotor and shaft assembly including the bearing assembly and another embodiment of an improved vacuum seal assembly.

### DETAILED DESCRIPTION

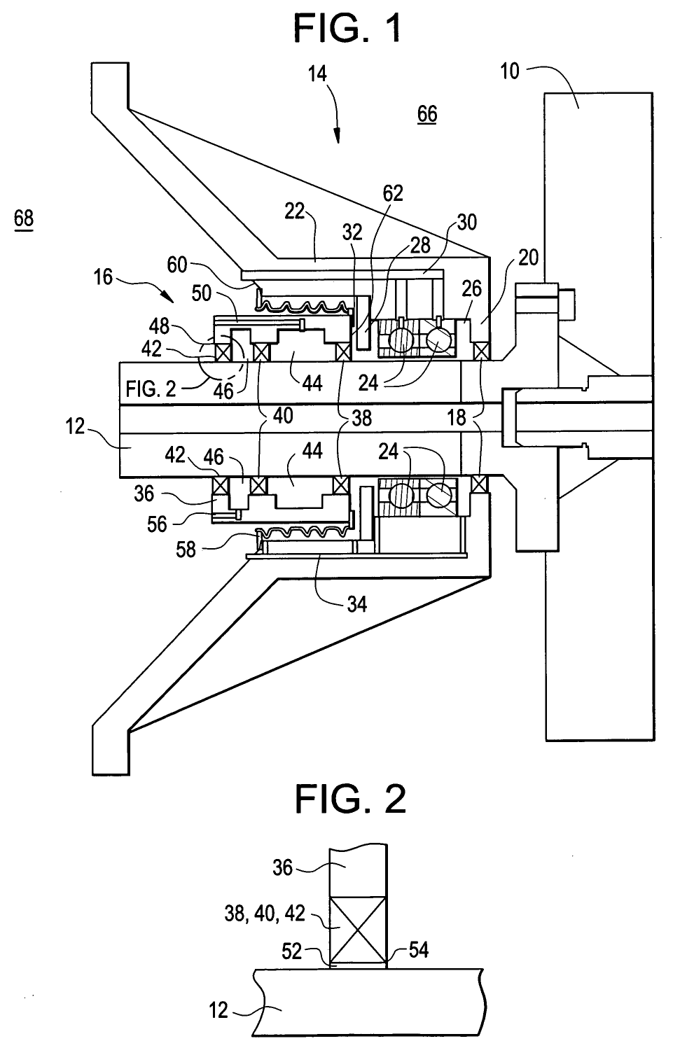

The present invention finds application in a variety of high speed generator applications, non-limiting examples of which include high temperature superconducting generator applications. Shown in FIG. 1 is an embodiment of high speed generator including a rotor 10 connected to a stub shaft 12. The stub shaft 12 is substantially cylindrical in shape, and the rotor 10 is connected to the stub shaft 12 at one end. The stub shaft 12 extends through a bearing assembly 14 and a vacuum seal assembly 16 to a drive mechanism (not shown) that drives the rotation of the stub shaft 12 and rotor 10.

The bearing assembly 14 in this embodiment includes a carbon seal ring 18 disposed at a rotor end 20 of a bearing stator 22. The bearing assembly 14 also includes one or more main bearings 24 disposed at a bearing stator inner diameter 26. The one or more main bearings 24 are positioned axially between the rotor end 20 and an end plate 28. The one or more main bearings 24 are lubricated by a lubricant introduced through one or more bearing feed conduits 30. Non-limiting examples of lubricants include fluorinated vacuum oils such as Krytox®. The one or more bearing feed conduits 30 extend through the bearing stator 22 to the bearing stator inner diameter 26. Lubricant is urged through the one or more bearing feed conduits 30 and applied to the one or more main bearings 24. When the lubricant is urged onto the main bearings 24, the lubricant forms a mist suspended in a bearing chamber 32. Excess lubricant in the bearing chamber 32 is collected in a plurality of bearing output conduits 34 and urged away from the bearing chamber 32.

The vacuum seal assembly 16 includes a seal stator 36 which is cylindrical in shape and surrounds the stub shaft 12 adjacent to the end plate 28. The vacuum seal assembly 16 includes at least three oil seals 38, 40 and 42, nonlimiting examples of which are carbon rings, Teflon®-based lip seals, and metal and carbon face seals. The oil seals 38, 40 and 42 define a vacuum side cavity 44 and an atmospheric side cavity 46 between an inner surface 48 of the seal stator 36 and the stub shaft 12. Lubricant is urged into the vacuum side cavity 44 through one or more seal feed conduits 50. The lubricant forms a mist in the vacuum side cavity 44, and as shown in FIG. 2 forms a lubricant film 52 on the inner diameter 54 of each of a vacuum side oil seal 38 and a center oil seal 40. Referring again to FIG. 1, a small amount of lubricant mist may leak into the bearing chamber 32, where it can be removed via the bearing output conduits 34. An amount of the lubricant mist may leak into the atmospheric side cavity 46. The lubricant mist will, as shown in FIG. 2, form a lubricant film 52 on an inner diameter 54 of an atmospheric side oil seal 42. Returning again to FIG. 1, one or more seal output conduits 56 are ported into the atmospheric side cavity 46 and extend through the seal stator 36, removing excess lubricant that leaks from the vacuum side cavity 44 to the atmospheric side cavity 46. Because the oil seals 38, 40 and 42 are non contact seals, the lubricant film 52 formed on each oil seal 38, 40 and 42, and the oil mist contained in the vacuum side cavity 44 and atmospheric side cavity 46 provide the necessary vacuum sealing around the circumference of the stub shaft 12 to maintain the integrity of the vacuum chamber.

A bellows seal 58 spans an area between an aft face 60 of the bearing stator 22 and a forward face 62 of the seal stator 36. The bellows seal 58 is connected to each of the aft face 60 of the bearing housing 22 and the forward face 62 of the seal stator 36. The bellows seal 58 completes a boundary between a vacuum chamber 66 (about 3.87e-4 psia) in which the rotor 10, bearing assembly 14, and vacuum seal assembly 16 are included, and an atmospheric chamber 68 (about 14.7 psia) into which the stub shaft 12 extends. The boundary is defined by the aft face 60 of the bearing stator 22, the bellows seal 58, the seal stator 36, and the atmospheric side carbon seal ring 42. In addition, the bellows seal 58 provides the vacuum seal assembly 16 with a lateral degree of freedom in the event of radial movement by the stub shaft 12 without affecting performance of the vacuum seal assembly 16.

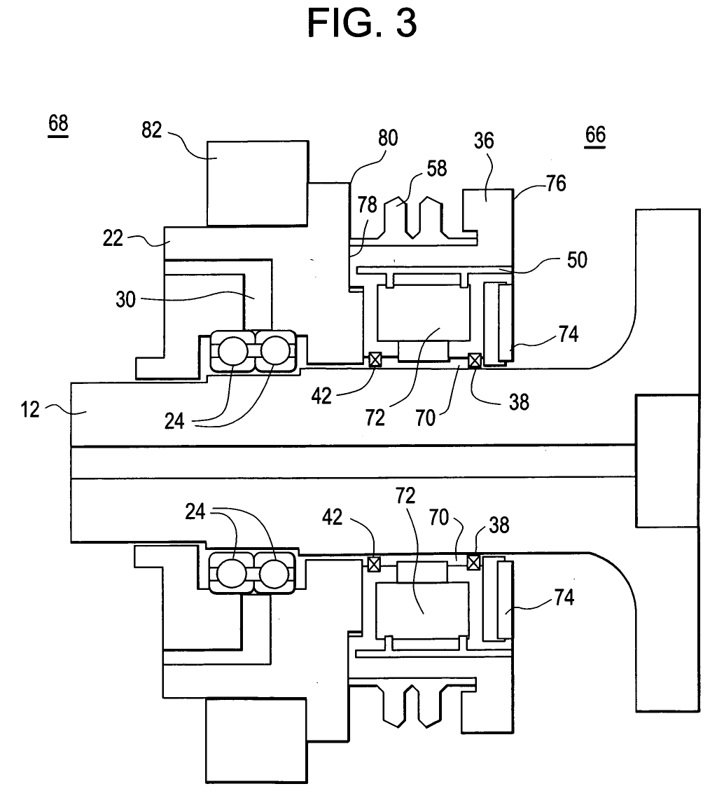

Another embodiment is shown in FIG. 3. The embodiment shown in FIG. 3 has the advantage of the main bearings 24 being disposed in an atmospheric environment, rather than a vacuum environment, so that the lubricant used for the main bearings 24 does not need to be effective in a vacuum environment and can be standard aerospace grade oil. The seal assembly 16 includes the seal stator 36 which is substantially cylindrical in shape and surrounds the stub shaft 12. The vacuum side oil seal 38 and the atmospheric side oil seal 42 are disposed between the inner surface 48 of the seal stator 36 and the stub shaft 12, creating a seal cavity 70 between the stub shaft 12 and the seal stator 36. Lubricant is urged into an oil cavity 72 through one or more seal feed conduits 50. The lubricant then proceeds through the oil cavity 72 into the seal cavity 70 as a mist. As shown in FIG. 2, the lubricant forms a lubricant film 52 on the inner diameter 54 of each of the vacuum side oil seal 38 and the atmospheric side oil seal 42. Returning to FIG. 2, a small amount of mist that leaks past the vacuum side oil seal 38 is prevented from entering the vacuum chamber 66 by a non-contact seal 74 disposed at a rotor-side face 76 of the seal stator 36. One or more seal output conduits 56 extend from the seal cavity 70 through the seal stator 36, removing excess lubricant from the seal cavity 36. Because the oil seals 38 and 42 do not contact the stub shaft 12, the lubricant film 52 formed on each oil seal 38 and 42, and the oil mist contained in the seal cavity 70 provide the necessary vacuum sealing around the circumference of the stub shaft 12 to maintain the integrity of the vacuum chamber.

The bearing assembly 14 is disposed at the non-rotor face 78 of the seal stator 36. The bearing assembly 14 comprises the bearing stator 22 and one or more main bearings 24 disposed at the bearing stator inner diameter 26. The one or more main bearings 24 are positioned axially between the seal stator 36 and the bearing stator 22. The one or more main bearings 24 are lubricated by a lubricant, in this case aerospace grade oil, introduced through one or more bearing feed conduits 30. The one or more bearing feed conduits 30 extend through the bearing stator 22 to the bearing stator inner diameter 26. Lubricant is urged through the one or more bearing feed conduits 30 and applied to the one or more main bearings 24. When the lubricant is urged onto the main bearings 24, the lubricant forms a mist suspended in the bearing chamber 32. Excess lubricant in the bearing chamber 32 is collected in a plurality of bearing output conduits 34 and urged away from the bearing chamber 32.

The bellows seal 58 spans an area between a bearing stator forward face 80 and the rotor-side face 76 of the seal stator 36. The bellows seal 58 is connected to each of the bearing stator forward face 80 and the rotor-side face 76. The bellows seal 58 completes a boundary between a vacuum chamber 66 in which the rotor 10 is included, and an atmospheric chamber 68 into which the stub shaft 12 extends. The boundary is defined by the non-contact seal 74, the rotor-side face 76 of the seal stator 36, the bellows seal 58, the bearing stator forward face 80 and an end frame 82.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A vacuum seal assembly for a high power generator stub shaft comprising:
a seal stator disposed about the stub shaft;
a plurality of oil seals disposed at an inner diameter of the seal stator and about the stub shaft defining a gap between each oil seal and the stub shaft for receiving a lubricant film, adjacent oil seals forming a plurality of seal cavities between the stub shaft and the seal stator;
at least one seal feed conduit extending through the seal stator into the plurality of seal cavities; and

2. The vacuum seal assembly of claim 1, wherein a lubricant film disposed at an inner diameter of each oil seal bridges the gap between the stub shaft and each oil seal.

3. The vacuum seal assembly of claim 1 further comprising at least one seal output conduit for removing excess lubricant from the plurality of seal cavities, wherein the seal conduit extends from at least one of the seal cavities through the seal stator.

4. The vacuum seal assembly of claim 1, wherein the plurality of oil seals is at least two oil seals.

5. The vacuum seal assembly of claim 1, wherein the plurality of seal cavities is two seal cavities.

6. The vacuum seal of claim 1, wherein at least one oil seal of the plurality of oil seals is a carbon seal ring.

7. A high speed generator comprising:
a stub shaft having a rotor attached at one end, the rotor disposed in a vacuum chamber and the stub shaft extending from the vacuum chamber to an atmosphere;
a bearing assembly disposed about the stub shaft adjacent to the rotor in the vacuum chamber; and
a vacuum seal assembly disposed adjacent to the bearing assembly and disposed about the stub shaft, the vacuum seal comprising:
a seal stator disposed about the stub shaft;
a plurality of oil seals disposed at an inner diameter of the seal stator and about the stub shaft defining a gap between each oil seal and the stub shaft for receiving a lubricant film, adjacent oil seals forming a plurality of seal cavities between the stub shaft and the seal stator;
at least one seal feed conduit extending through the seal stator into the plurality of seal cavities; and

8. The high speed generator of claim 7, wherein a lubricant film disposed at an inner diameter of each oil seal bridges the gap between the stub shaft and each oil seal.

9. The high speed generator of claim 7 further comprising a bellows seal connected to a seal stator face and to a bearing stator face such that a radial space between the seal stator and a bearing stator is closed, thus completing a segregation of the vacuum chamber from the atmosphere.

10. The high speed generator of claim 7 further comprising at least one seal output conduit for removing excess lubricant from the plurality of seal cavities, wherein the seal conduit extends from at least one of the seal cavities through the seal stator.

11. The high speed generator of claim 7, wherein the plurality of oil seals is three oil seals.

12. The high speed generator of claim 7, wherein the plurality of seal cavities is two seal cavities.

13. The high speed generator of claim 7, wherein at least one oil seal of the plurality of oil seals is a carbon seal ring.

14. The high speed generator of claim 7, wherein the stub shaft is substantially cylindrically shaped.

15. A high speed generator comprising:
a stub shaft having a rotor attached at one end, the rotor disposed in a vacuum chamber and the stub shaft extending from the vacuum chamber to an atmosphere;
a vacuum seal assembly disposed adjacent to the bearing assembly and disposed about the stub shaft, the vacuum seal comprising:
a seal stator disposed about the stub shaft;
a plurality of oil seals disposed at an inner diameter of the seal stator and about the stub shaft defining a gap between each oil seal and the stub shaft for receiving a lubricant film, adjacent oil seals forming a plurality of seal cavities between the stub shaft and the seal stator;
at least one seal feed conduit extending through the seal stator into the plurality of seal cavities; and
a bearing assembly disposed about the stub shaft adjacent to the seal assembly in the atmosphere.

16. The high speed generator of claim 15, wherein a lubricant film disposed at an inner diameter of each oil seal bridges the gap between the stub shaft and each oil seal.

17. The high speed generator of claim 15 further comprising a non-contact seal disposed at a rotor-side face of the seal stator preventing lubricant from the plurality of seal cavities from entering the vacuum chamber.

18. The high speed generator of claim 15 further comprising a bellows seal connected to a seal stator face and to a bearing stator face such that a radial space between the seal stator and a bearing stator is closed, thus completing a segregation of the vacuum chamber from the atmosphere.

19. The high speed generator of claim 15 further comprising at least one seal output conduit for removing excess lubricant from the plurality of seal cavities, wherein the seal conduit extends from at least one of the seal cavities through the seal stator.

20. The high speed generator of claim 15, wherein the plurality of oil seals is two oil seals.

21. The high speed generator of claim 15, wherein the plurality of seal cavities is one seal cavity.

22. The high speed generator of claim 15, wherein at least one oil seal of the plurality of oil seals is a carbon seal ring.

23. The high speed generator of claim 15, wherein the stub shaft is substantially cylindrically shaped.
